(19) United States
(12) Patent Application Publication
(10) Pub. No.: US 2006/0070711 A1
(43) Pub. Date: Apr. 6, 2006

(54) Low pH treatment of pulp in a bleach sequence to produce pulp having low D.P. and low copper number for use in lyocell manufacture

(76) Inventor: Mengkui Luo, Tacoma, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 10/956,915

(22) Filed: Sep. 30, 2004

(51) Int. Cl. D21C 3/18; C08L 1/00

(52) U.S. Cl. 162/88; 162/78; 162/67; 162/89; 524/35

(57) ABSTRACT

A high pH and a low pH process for reducing the degree of polymerization of a pulp having a hemicellulose content of at least 7%. The high pH is greater than 8, and the low pH process is 2 to 8. The high pH process reduces the degree of polymerization without substantially increasing the copper number. The low pH process requires a subsequent treatment with alkali to reduce the copper number of the pulp to less than 2. The process can be practiced in pulp mills with a bleaching sequence having one or more E or D stages. At the end of the bleach sequence, a pulp having a degree of polymerization of 200 to 1100, a copper number of less than 2, and a hemicellulose content of at least 7% is provided. The pulp can be used to make lyocell fibers.

### FIELD OF THE INVENTION

The present invention provides methods for reducing the degree of polymerization of pulps without substantially reducing the hemicellulose content. The resultant pulp product has a low copper number and can be used to make lyocell fibers.

### BACKGROUND OF THE INVENTION

Lyocell fibers are typically made from highly processed pulp known as “high alpha” pulp that is mostly cellulose and has had much of the hemicellulose and lignin removed. The highly purified “alpha pulps” are expensive to manufacture. A common process known as “Kraft” is used widely for the production of a pulp that is lower in cellulose and higher in hemicellulose as compared with the “high alpha” pulps. The Kraft method of pulping is generally one of the most efficient of all pulping methods. However, it is believed that the relatively large amounts of hemicellulose that are retained in Kraft pulp renders the pulp unsuitable for use in lyocell manufacture. Recently, there have been a number of issued patents, assigned to the assignee of the present invention, which describe methods for producing pulps that are high in hemicellulose content, but have nevertheless been successfully spun into lyocell fibers. Such prior technology is centered on reducing the degree of polymerization (D.P.) of cellulose. Such reduction in degree of polymerization is thought to be responsible for the ability of the high hemicellulose pulp to fully dissolve in amine N-oxide solvents, and be spun into lyocell fibers.

Copper number represents the carbonyl content of pulp. It is generally believed that a high copper number will lead to degradation of the amine N-oxide solvent. Accordingly, to be useful for lyocell manufacture, pulp has to have a certain range of copper number. In U.S. Pat. No. 6,210,801, incorporated herein by reference, methods are described that reduce the degree of polymerization of the cellulose of pulp without substantially reducing the hemicellulose content. These methods include treating the pulp with an acid or combination of acids; treating the pulp with steam; treating the pulp with a combination of ferrous sulfate and hydrogen peroxide; treating the pulp with a combination of a transition metal and peracetic acid; and treating the pulp with alkaline chlorine dioxide or with alkaline sodium hypochlorite. However, the ferrous sulfate is present at a concentration of from about 15000 ppm to 90000 ppm. The aforementioned methods require that a second, subsequent treatment be performed in order to reduce the copper number of the pulp to an acceptable level. In the '801 patent, the copper number is reduced by treating the pulp with sodium borohydride or sodium hydroxide, or by treating the pulp with one or more bleaching agents.

In U.S. Pat. No. 6,331,354, incorporated herein by reference, methods are described that eliminated the need to have a subsequent treatment to lower the copper number after reducing the degree of polymerization of the cellulose. This alternate method lowered the degree of polymerization without substantially decreasing the hemicellulose content and also without substantially increasing the copper number. The method uses an oxygen reactor operated under alkaline conditions. An oxygen reactor is typically included after the brown stock washers and before the bleaching sequence, and is used to destroy or solubilize the colorant materials in pulp. The '354 patent describes conditions for operating an oxygen reactor to reduce the degree of polymerization of cellulose without substantially reducing the hemicellulose content or increasing the copper number.

Regardless of the advances made in reducing the degree of polymerization of cellulose in pulp, there are still opportunities to develop alternatives for reducing the degree of polymerization without substantially reducing the hemicellulose content and providing pulp with a suitable copper number. The present invention provides alternative strategies of reducing the degree of polymerization of high hemicellulose pulps that can be practiced in some existing pulp mills with bleaching sequences. The pulp mills are otherwise unable to produce pulp with a low degree of polymerization without having to increase the amounts of bleach chemicals and bleach temperature from the normal conditions.

### SUMMARY OF THE INVENTION

A high pH and a low pH process for reducing the degree of polymerization of a pulp having a hemicellulose content of at least 7%, is described. The high pH process is carried out at a pH greater than 8, and the low pH process is carried out at a pH of 2 to 8. The high pH process reduces the degree of polymerization without substantially increasing the copper number. The low pH process requires a subsequent treatment with alkali to reduce the copper number of the pulp to less than 2. The process can be practiced in pulp mills with a bleaching sequence having one or more E or D stages. At the end of the bleach sequence, a pulp having a degree of polymerization of 200 to 1100, a copper number of less than 2, and a hemicellulose content of at least 7% is provided. The pulp can be used to make lyocell fibers.

The present invention can produce pulps of low degree of polymerization in an existing pulp mill's bleaching sequence without a substantial adjustment to the amounts of chemicals and temperatures normally used.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram of a bleach sequence process according to the invention;

FIG. 2 is a schematic diagram of an alternate bleach sequence process according to the invention; and

FIG. 3 is a schematic diagram of a process to make lyocell fibers.

### DETAILED DESCRIPTION OF THE PREFERRED EMBODIMENT

Much of the chemical pulp being produced by the Kraft process is put through a bleaching sequence for the removal of the colorant components in pulp. The bleaching sequence can comprise one or more bleach stages that are designated by the letters C, E, H, D, P, and O. Each stage refers to the specific chemical used in the bleaching of pulp. There are, of course, almost infinite variations of temperature, chemical dosage, pressure, and pulp consistency that can be used at each stage of bleaching. A thorough discussion of bleaching chemistry is not necessary here, however, reference is made to the “Handbook of Pulping and Papermaking” by Christopher S. Biermann. A consequence of bleaching pulp is a concurrent degradation of cellulose. Degradation of cellulose outside the context of the prior patents described in the background section, related patents and applications, and the present application is disadvantageous because it leads to a decrease in pulp strength. However, while some prior art teaches the prevention of the degradation of cellulose during bleaching (see, for example, Samuelsson, U.S. Pat. No. 5,985,097), the present invention seeks to accelerate the degradation of cellulose with a catalyst in one or more stages of bleaching or between stages to produce pulps that are suitable for lyocell manufacture. With the addition of a catalyst in a bleaching stage or interstage between stages, the overall bleach sequence process according to the invention lowers the degree of polymerization of the cellulose in pulp to within the range of about 200 to about 1100, without significantly reducing the hemicellulose content of the pulp. The copper number is adjusted to be less than or about 2, either concurrently with the reduction in the degree of polymerization or subsequent to the reduction in the degree of polymerization. The process according to the invention can be practiced in pulp mills with bleach sequences that normally produce high hemicellulose pulps that are otherwise unsuitable for lyocell manufacture. The process according to the invention can render the pulps useful for lyocell manufacture.

The process according to the present invention can be practiced in bleach sequences having a D stage using chlorine dioxide and an E stage or extraction stage using sodium hydroxide and hydrogen peroxide. Because some of the current bleach sequence conditions in existing bleach plants are too mild to reduce the degree of polymerization of cellulose to the range of about 200 to about 1100, a catalyst is added to a bleach stage or interstage between stages in the bleach sequence to increase the overall reduction of the degree of polymerization of cellulose. It is to be appreciated that while hydrogen peroxide is the preferred chemical for use in the E stage, other oxidants can be used. Similarly, while sodium hydroxide is the preferred chemical for use in the E stage other alkali chemicals can be used. Furthermore, while each stage of bleaching generally is carried out in a single bleaching tower devoted to one stage of bleaching, it is possible to practice the invention in one or more bleaching towers, where more than one stage of bleaching can be carried out in a single bleaching tower or where one stage can be practiced in one or more towers.

Chemical pulp, such as Kraft pulp, after it has been washed in brownstock washers, is normally “bleached” to remove the colorant components found in the pulp. Brownstock pulp that has been chemically digested according to the Kraft process under alkaline conditions, and has not had an acidic prehydrolysis treatment, will contain an amount of hemicellulose that is at least 7% by weight as measured by a sugar content assay based on a proprietary Weyerhaeuser sugar content assay (AM W-LC-wood pulp). The reduction in the degree of polymerization takes place without substantially reducing the hemicellulose content of the pulp. Throughout this application, the phrase, “without substantially reducing the hemicellulose content” means without reducing the hemicellulose content by more than about 50%, preferably not more than about 15%, and most preferably not more than about 5% during the D.P. reduction step.

According to the present invention, a catalyst to reduce the degree of polymerization of the cellulose of a pulp is provided in an E stage, or before an E stage but after a D stage, or before both a D and an E stage. According to the present invention, there is a high pH process and a low pH process for the reduction of the degree of polymerization. The low pH process reduces the degree of polymerization of cellulose below at a pH of 2 to 8. When the reduction in degree of polymerization takes place at a low pH, a subsequent treatment with an alkali, such as sodium hydroxide, is performed to reduce the copper number to less than or about 2. This subsequent alkali treatment can advantageously take place in an E stage where hydrogen peroxide still exists. Ideally, for low pH, degree of polymerization reduction, the time to reduce the degree of polymerization and the time to reduce the copper number are respectively about 10 minutes and about 45 minutes. However, when practiced in a mill, the times can be longer.

As an alternative to the low pH process, the reduction of the degree of polymerization of cellulose of a pulp can occur at a pH greater than 8. When the reduction in degree of polymerization takes place at a high pH of greater than 8, there is no need to perform a subsequent alkali treatment to reduce the copper number to less than 2. The high pH process to reduce the degree of polymerization of cellulose takes place both without substantially decreasing the hemicellulose content and also without substantially increasing the copper number. Throughout this application, the phrase “without substantially increasing the copper number,” means without increasing the copper number by more than about 100%, preferably not more than about 50%, and most preferably not more than about 25% during reducing the degree of polymerization. Copper number is measured by Weyerhaeuser method AM W-PPD-3. A useful copper number range of pulp produced by the process according to the invention is less than or about 2. Sodium hydroxide in an amount of about 1.5% based on the weight of the pulp weight is added to reduce the copper number of pulp to less than 2. The high pH process is suited to reduce the degree of polymerization of cellulose when the starting degree of polymerization of cellulose of a pulp is about 1050, or less. In contrast, the low pH process is suited to reduce the degree of polymerization of cellulose of a pulp when the starting degree of polymerization is up to 2000. Reduction of the degree of polymerization at a pH greater than 8 will result in about a 20% to 40% reduction of degree of polymerization from the starting value. Reduction of the degree of polymerization at a pH of 2 to 8 will result in about a 10% to about 20% reduction in degree of polymerization from the starting value. Degree of polymerization is measured using ASTM Test D1795.

According to one embodiment of the present invention, in a high pH process of pH greater than 8, a catalyst is added in an E_{P} stage to reduce the degree of polymerization of cellulose. An E_{P} stage is a hydrogen peroxide reinforced extraction stage using sodium hydroxide. A catalyst useful in the present invention provides transition metal ions that catalyze the reduction of degree of polymerization of cellulose. Such catalyst includes a transition metal having a positive oxidation state or cation, such as: Fe(II), Fe(III), Mn(II), Cu(II), Cu(I), Co(II), Co(III), Ni(II). Of these, the preferred catalysts are iron and copper cations: Fe(II), Fe(III), Cu(II). Catalysts also include any of the salts of the aforementioned metal ion species, and any combinations thereof.

According to one embodiment of the present invention, in a high pH process of at least a pH of 8, a catalyst, hydrogen peroxide and sodium hydroxide are added to an E stage. In any one of the E stages used to reduce the degree of polymerization, an effective amount of catalyst is in the range of about 0.1 ppm to about 30 ppm based on the weight of pulp. An effective amount of hydrogen peroxide is about 1% to about 3% based on the weight of pulp. An effective amount of sodium hydroxide is about 1% to about 4% based on the weight of pulp. Sodium hydroxide is used to provide the perhydroxyl ion and to maintain the pH above a value of 8. The temperature of the E_{P} stage is about 75° C. to about 90° C. At a high pH of greater than 8, the stage will lower the degree of polymerization of cellulose without substantially increasing the copper number.

According to one embodiment of the present invention, in a low pH process of pH 2 to 8, a catalyst, hydrogen peroxide and optionally sodium hydroxide or an acid are added to a vessel ahead of an E stage. The vessel is provided with sodium hydroxide and hydrogen peroxide to reduce the degree of polymerization of cellulose, and if necessary, the vessel may be provided with an amount of acid to maintain the pH from about 2 to about 8. The acid may be from carbon dioxide gas. The reduction in the degree of polymerization of cellulose occurring ahead of an E stage leaves the E stage to be used as the copper control stage in addition to further degree of polymerization reduction. The amount of catalyst is about 0.1 ppm to about 30 ppm based on the weight of the pulp. The amount of hydrogen peroxide is about 1% to about 3% based on the weight of the pulp. The amount of sodium hydroxide is about 1% to about 4% based on the weight of the pulp. The temperature can be about 50° C. to about 100° C. The reduction of degree of polymerization at a low pH requires a subsequent treatment with sodium hydroxide to lower the copper number to less than 2.

In another embodiment of the present invention, in a low pH process of a pH of 2 to 8, the E stage is provided with a catalyst, sodium hydroxide and hydrogen peroxide within the quantities stated above, to reduce the degree of polymerization of cellulose. The bleach sequence can be provided with a second E stage that is used for copper number control. If the E stage is preceded by a D stage, it is advantageous to add the catalyst, sodium hydroxide, and hydrogen peroxide to reduce the degree of polymerization of cellulose interstage between the D and E stages, since the effluent out of a D stage will normally have a pH of about 2 to about 8. The need to add an acid to maintain the pH at a low level is avoided.

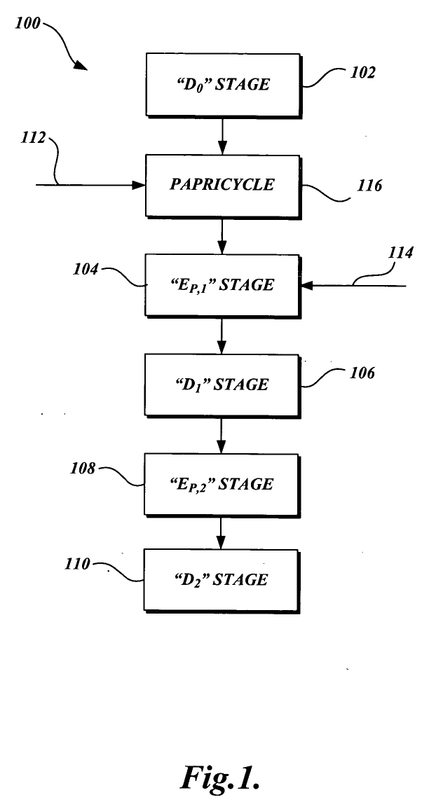

Referring to FIG. 1, a representative bleach sequence is provided which includes a D₀ stage (block 102), E_{P,1} stage (block 104), D₁ stage (block 106), E_{P,2} stage (block 108), and a D₂ stage (block 110). For a high pH, degree of polymerization reduction, the catalyst may be added at either the first or second E_{P} stage. Shown in FIG. 1, is addition of a catalyst 114 in the first E stage, block 104. It may be advantageous to carry out the reduction of the degree of polymerization in the E_{P,1} stage, and the E_{P,2} stage can be used for further adjustment of the degree of polymerization, if necessary. Carrying out the bleach process depicted in FIG. 1, with the addition of a catalyst before or in at least one E stage will result in a pulp having a degree of polymerization of about 200 to about 1100, a hemicellulose content of at least 7%, and a copper number of less than 2.

Referring still to FIG. 1, for low pH, degree of polymerization reduction, the catalyst may be added interstage between the D₀ and the E_{P,1} stage at location 112. This is advantageous, since the effluent out of the D₀ stage will be at a pH of about 2. Therefore, the need to add acid to bring the pH between about 2 to about 8 will be partially or totally avoided. The bleach sequence of FIG. 1 is equipped with an additional vessel to carry out a step known as “papricycle”, block 116. The papricycle step would normally treat the pulp with alkali in between a D and E stage. However, if the papricycle vessel is used for the reduction of degree of polymerization, the addition of alkali to a papricycle step can be avoided, since the reduction in degree of polymerization is preferably done at a low pH, such as in the effluent from the D₀ stage. Therefore, the first or the second E stage can be used to control the copper number to about 2 by the addition of an alkali and peroxide. Alternatively, low pH, degree of polymerization reduction can be carried out in the first E_{P,1} stage, leaving the second E_{P,2} stage for copper number control.

An advantage of the present invention is that the use of a catalyst can reduce the degree of polymerization of cellulose of a pulp without any substantial adjustment to the normal rates of chemicals or temperatures normally used in the bleach stages. In some instances, the use of bleaching chemicals may be reduced from the normal amounts with the use of a catalyst. The typical operating conditions of the bleach sequence of FIG. 1, are provided below.

In the first D₀ stage, block 102, the pulp consistency is adjusted to about 10% with the addition of water. Chlorine dioxide corresponding to an amount of about 0.5 to 1.5% weight based on the weight of the pulp, is added. The mixture is held at a temperature from about 65° C. to about 75° C. for about 40 to about 90 minutes.

In the papricycle stage, block 116, sodium hydroxide is added at about 0.5% to about 1.5% based on the weight of the pulp. The temperature is about 60° C. to about 80° C., and the duration is about 15 to 60 minutes.

In the first E_{P,1} stage, block 104, the pulp consistency is maintained at about 10% with the addition of water. Sodium hydroxide is charged to the stage in an amount of about 1.5% to about 3% based on the weight of the pulp. Hydrogen peroxide is charged to the stage in an amount of about 1% to about 3% based on the weight of the pulp. The temperature is about 75° C. to about 90° C. The stage duration is about 50 to about 90 minutes.

In the second D₁ stage, block 106, chlorine dioxide is added in an amount of about 0.5% to about 1.5% based on the weight of the pulp, and the pulp was again diluted to bring the consistency to about 10%. The temperature is about 70° C. to about 85° C. The stage duration is about 60 to about 90 minutes.

In the second E_{P,2} stage, block 108, sodium hydroxide is charged to the stage with water being added to achieve a consistency of about 10%. The sodium hydroxide charge is about 1.5% to about 3.5% based on the weight of the pulp. Hydrogen peroxide is also charged in an amount of about 1% to about 3% based on the weight of the pulp. The temperature is about 80° C. to about 90° C. The stage duration is about 50 to about 90 minutes.

In the second D₂ stage, block 110, chlorine dioxide is charged at about 0.3% to about 1% based on the weight of the pulp. The temperature is about 70° C. to about 85° C. The stage duration is about 60 to about 90 minutes.

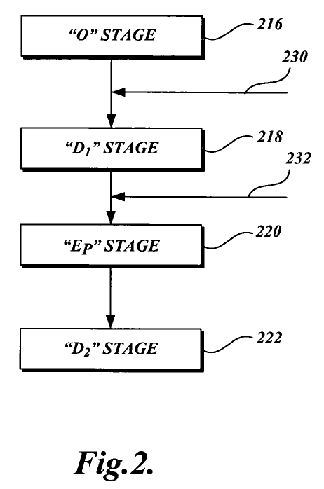

Referring to FIG. 2, another representative bleach sequence according to the present invention is provided. The bleach sequence includes an O stage (block 216), D₁ stage (block 218), E_{P} stage (block 220), and a D₂ stage (block 222). Bleach sequences having a single E stage, can use the high pH or low pH process for reduction of degree of polymerization.

In one embodiment, using high pH, degree of polymerization reduction, the catalyst, hydrogen peroxide, and sodium hydroxide is added to the single E_{P} stage, block 220, which reduces the degree of polymerization of cellulose, without substantially increasing the copper number and without substantially reducing the hemicellulose content.

In one embodiment, using low pH, degree of polymerization reduction, the catalyst is added before the D₁ stage and interstage between the O and the D₁ stages at location 230. If added interstage between the O and the D₁ stages, then it may be necessary to add acid to lower the pH to about 2 to about 8. The acid can be carbon dioxide gas. A vessel, such as a mixer or tower may be provided interstage between the O and the D₁ stages for use in the reduction of degree of polymerization. The E_{P} stage is then used for the lowering the copper number to less than 2 with an alkali, such as sodium hydroxide.

In one embodiment, the low pH, degree of polymerization reduction may be carried out in an E_{P} stage, block 220. Catalyst, sodium hydroxide, and hydrogen peroxide is added to the E_{P} stage. The E_{P} stage may be split into two vessels or towers, wherein the low pH degree of polymerization reduction occurs in a first tower of the E_{P} stage, and the copper number control to reduce the copper number to about 2 occurs in a second vessel or tower of the E_{P} stage.

In one embodiment, the low pH, degree of polymerization reduction may be carried after the D₁ stage, block 218, but before the E_{P} stage, block 220. Catalyst, sodium hydroxide, and hydrogen peroxide is added before the E_{P} stage at location 232, which will advantageously be at a pH of 2 to 8 already due to the effluent from the D₁ stage. In this case, sodium hydroxide and acid is optional to maintain pH from 2 to 8. The E_{P} stage may than be used for copper number control to reduce the copper number to about 2.

An advantage of the present invention is that the use of a catalyst can reduce the degree of polymerization of cellulose of pulp without any substantial adjustment to the normal rates of chemicals or stage temperatures. In some instances, the use of bleaching chemicals may be reduced from the normal amounts with the use of a catalyst. The typical operating conditions of the bleach sequence of FIG. 2, are provided below.

The first stage of bleaching is an O stage, block 216. The O stage comprises bleaching with oxygen. Oxygen bleaching is bleaching with oxygen under pressure. Oxygen is considered to be less specific for the removal of colorant components than the chlorine compounds. Oxygen bleaching takes place in an oxygen reactor. The reactor can operate at a high consistency, wherein the consistency of the feedstream to the reactor is greater than 20% or it can operate at medium consistency, where the medium consistency ranges between 8% up to 20%. Preferably, if a high consistency oxygen reactor is used, the oxygen pressure can reach the maximum pressure rating for the reactor, but more preferably is greater than 0 to about 85 psig. In medium consistency reactors, the oxygen can be present in an amount ranging from greater than 0 to about 100 pounds per ton of the pulp, but is more preferably about 50 to about 80 pounds per ton of pulp. The temperature of the 0 stage ranges from about 100° C. to about 140° C.

The D₁ stage, block 218, comprises bleaching the pulp coming from the oxygen reactor with chlorine dioxide. The amount of chlorine dioxide used in this stage ranges from about 0.5% to 1.5% based on the weight of the pulp. The temperature of the D₁ stage ranges from about 70° C. to about 100° C. The stage duration is about 60 to about 90 minutes.

The E_{P} stage, block 220, is the hydrogen peroxide reinforced extraction stage where the pulp is treated using sodium hydroxide in an amount ranging from about 1.5% to about 5% based on the weight of the pulp. The amount of hydrogen peroxide ranges from about 1.5% to about 3% based on the weight of the pulp. The temperature of the E_{P} stage ranges from about 80° C. to about 95° C. The stage duration is about 60 to about 90 minutes.

In one embodiment, the second D₂ stage, block 222, follows the E_{P} stage, block 220. The amount of chlorine dioxide used in this stage ranges from about 0.5% to about 1.5% based on the weight of the pulp. The temperature of the D₂ stage ranges from about 70° C. to about 90° C. The stage duration is about 60 to about 90 minutes.

According to the present invention, any of the aforementioned schemes for reducing the degree of polymerization of cellulose results in a pulp having a degree of polymerization of cellulose of about 200 to about 1100, a copper number of less than 2, a hemicellulose content of at least 7%.

A typical mill will have undesired metals, such as magnesium and calcium in the water, which can be introduced into the pulp. Magnesium and calcium compounds may have a deactivating effect on the catalyst. Ca(II) and Mg(II) ion species in water were discovered to deactivate the catalyst and prevent cellulose degradation. The metals can be removed by the addition of a chelating agent with the catalyst in or before any of the D or E stages. Suitable chelating agents, include, but are not limited to aminopolycarboxylic acids (APCA), ethylenediaminetetraacetic acid (EDTA), diethylene triamine pentaacetic acid (DTPA), nitrilotriacetic acid (NTA), phosphonic acids, ethylenediaminetetramethylene-phosphonic acid (EDTMP), diethylenetriaminepentamethylenephosphonic acid (DTPMP), nitrilotrimethylenephosphonic acid (NTMP), polycarboxylic acids, gluconates, citrates, polyacrylates, and polyaspartates or any combination thereof. A chelating agent may be added in an amount up to 0.1% by weight based on the weight of the pulp. In addition to the chelating agents, the pulp may be washed under acidic conditions to remove the normally occurring metals before or after the process to reduce the degree of polymerization. In bleach sequences having a D stage as the last stage of the bleach sequence, the D stage can wash out the normally occurring metals and catalysts.

The present invention therefore provides a pulp useful for lyocell manufacture that has a degree of polymerization in the range of about 200 to about 1100, at least 7% hemicellulose by weight, and a copper number that is less than 2. The pulp can also have total transition metals (iron, manganese, copper, cobalt and nickel) content of less than 25 ppm. Transition metals are measured using Weyerhaeuser method AM T-266M/E 6010. Pulps treated in accordance with the invention also exhibit a low ΔR (hereinafter Delta R), which is the differential between R₁₀ and R₁₈. R₁₀ refers to the residual undissolved material that is left after attempting to dissolve the pulp in a 10% caustic solution. R₁₈ refers to the residual amount of undissolved material left after attempting to dissolve the pulp in an 18% caustic solution. R₁₀ and R₁₈ are measured using Weyerhaeuser method AM T-235.

The pulp treated in accordance with the present invention can be dissolved in a solvent and spun into lyocell fibers by meltblowing, centrifugally spinning, or spunbounding a solution of cellulose as described in U.S. Pat. No. 6,235,392, incorporated herein by reference. Alternatively, a dope produced by the pulp made in accordance with the present invention can be spun in any conventional manner used for high alpha pulps

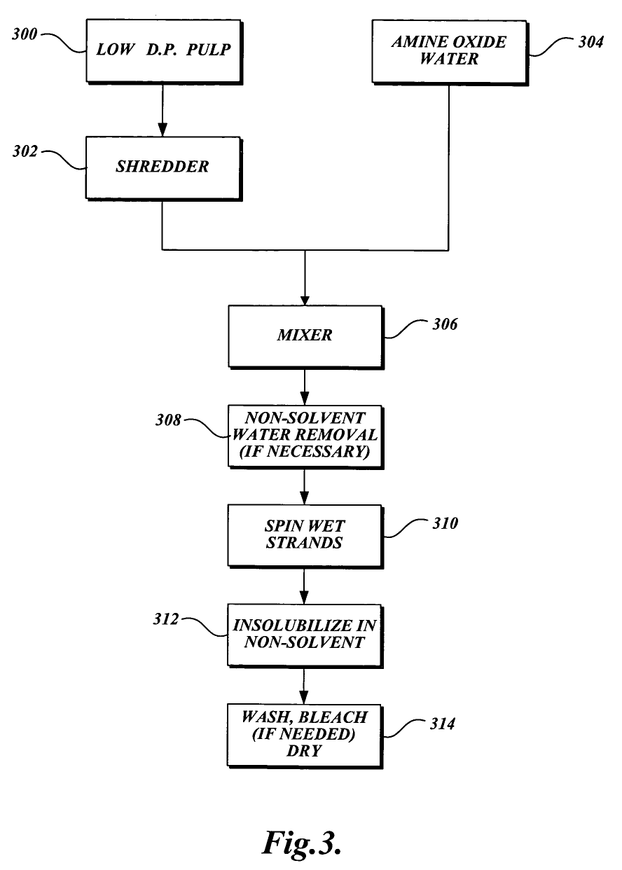

FIG. 3 shows a block diagram of one embodiment of a method for forming lyocell fibers from the pulps made according to the present invention. Starting with pulp that has had the D.P. reduced in block 300, the pulp is physically broken down, for example by a shredder in block 302. The pulp is dissolved with an amine oxide-water mixture to form a dope, block 304. The pulp can be wetted with a non-solvent mixture of about 40% NMMO and 60% water. The mixture can be mixed in a double arm sigma blade mixer and sufficient water distilled off to leave about 12-14% based on NMMO so that a cellulose solution is formed, block 306. Alternatively, NMMO of appropriate water content may be used initially to eliminate the need for the vacuum distillation block 308. This is a convenient way to prepare spinning dopes in the laboratory where commercially available NMMO of about 40-60% concentration can be mixed with laboratory reagent NMMO having only about 3% water to produce a cellulose solvent having 7-15% water. Moisture normally present in the pulp should be accounted for in adjusting the water present in the solvent. Reference is made to articles by Chanzy, H., and A. Peguy, Journal of Polymer Science, Polymer Physics Ed. 18:1137-1144 (1980), and Navard, P., and J. M. Haudin, British Polymer Journal, p. 174 (December 1980) for laboratory preparation of cellulose dopes in NMMO and water solvents. A third alternative for making dope, is to mix the pulp with water, followed by dewatering the pulp, and then dissolving the pulp with NMMO.

The dissolved, bleached pulp (now called the dope) is forced through extrusion orifices in a process called spinning, block 310, to produce cellulose filaments that are then regenerated with a non-solvent, block 312. Spinning to form lyocell-molded bodies, including fibers, films, and nonwovens, may involve meltblowing, centrifugal spinning, spun bonding, and dry-jet wet techniques. Finally, the lyocell filaments or fibers are washed, block 314.

### EXAMPLE A

### Reduction of Degree of Polymerization at High pH with a Catalyst

Once dried pulp (NB416 fluff pulp available from the Weyerhaeuser Co. of Federal Way, Wash.) now having a consistency of 10% was mixed with 1.5% NaOH (based on pulp weight) and 1.5% H₂O₂ (based on pulp weight) in a container and bleached at 90° C. for one hour in a lab. A catalyst was added to increase the reduction of degree of polymerization of cellulose. A control sample has a degree of polymerization of 1310. The results are summarized in Table 1.

TABLE 1
CATALYSTS FOR H₂O₂ BLEACHING OF PULP

| | | Catalyst | | |
|---|---|---|---|---|
| | | in water | D.P. | D.P. |
| Pulp | Catalyst | (ppm) | (post treatment) | drop (%) |
| NB416-dry | None | | 1310 | |
| NB416-dry | Water/H₂O₂/NaOH | none | 1165 | 11 |
| NB416-dry | FeCl₂.4H₂O | 13.6 | 1015 | 23 |
| NB416-dry | FeCl₃.6H₂O | 11.2 | 894 | 32 |
| NB416-dry | MnCl₂.3H₂O | 13.5 | 1241 | 5 |
| NB416-dry | MnCl₂ | 11.2 | 1242 | 5 |

### EXAMPLE B

### Reduction of Degree of Polymerization at High pH with a Catalyst

Never dried pulp from the Weyerhaeuser Company's Kamloops mill from the D₁ stage having a consistency of 10% was mixed with NaOH and H₂O₂ in a container and bleached 90° C. for one hour in a lab. Sodium hydroxide was added at the rate of 1.5%, and hydrogen peroxide was added at the rate of 1.5%, where percent is based on the weight of the pulp, unless otherwise indicated. A catalyst was added to catalyze the reduction of degree of polymerization of cellulose. The pH was greater than 8. A control sample has a degree of polymerization of 939. Some of the samples were washed with deionized (DI) water prior to bleaching. The results are summarized in Table 2.

TABLE 2
CATALYST EFFECTIVENESS FOR BLEACHING OF MILL SAMPLES

| | | Catalyst | D.P./copper | |
|---|---|---|---|---|
| | | in water | number (post | |
| Pulp | Catalyst | (ppm) | treatment) | D.P. drop (%) |
| Kamloops D1 | None | | 939 | |
| Kamloops D1 | Water/H₂O₂/NaOH | 0 | 781 | 17 |
| Kamloops D1 | Double H₂O₂ | 0 | 698/0.8 | 26 |
| Kamloops D1 | FeCl₃.6H₂O | 13 | 694/0.8 | 26 |
| Kamloops D1 | FeCl₃.6H₂O | 3 | 754 | 20 |
| Kamloops D1 | MnCl₂ | 27 | 895 | 5 |
| Kamloops D1 | MnCl₂ | 13.5 | 876 | 7 |
| Kamloops D1 | MnCl₂ | 3 | 884 | 6 |
| Kamloops D1 | FeCl₃.6H₂O/MnCl₂ | 3/80 | 911 | 3 |
| Kamloops D1 | FeCl₃.6H₂O/MnCl₂ | 9/40 | 886 | 6 |
| Kamloops D1 | FeCl₃.6H₂O/MnCl₂ | 6/60 | 903 | 4 |
| Kamloops D1 | CuCl₂.2H₂O* | 12 | 664/1 | 29 |
| Kamloops D1 | CuCo₃Cu(OH)₂* | 12 | 670/0.9 | 29 |
| Kamloops D1 | CuSO₃* | 12 | 655/0.9 | 30 |
| Kamloops D1 | CoCO₃* | 12 | 811/0.6 | 14 |

*1.1% NaOH and 1.5% H₂O₂ based on pulp weight.

| | | | | |
|---|---|---|---|---|
| Kamloops D1 | FeCl₃.6H₂O | 8 | 767/0.8 | 18 |
| (lab DI water | | | | |
| washed) | | | | |
| Kamloops D1 | MnCl₂ | 7 | 895 | 5 |
| (lab DI water | | | | |
| washed) | | | | |
| Kamloops D1 | FeCl₃.6H₂O/MnCl₂ | 7/7 | 895 | 5 |
| (lab DI water | | | | |
| washed) | | | | |
| Kamloops D1 | Water/H₂O₂/NaOH* | 0 | 629 | 33 |
| (lab DI water | | | | |
| washed) | | | | |
| Kamloops D1 | Water/H₂O₂/NaOH* | 0 | 686/0.9 | 27 |
| (no wash) | | | | |

*Comparative bleaching under the following chemical amounts: 1.5% NaOH and 3.0%
H₂O₂ based on pulp weight.

These results indicate that 3 ppm Fe (III) can enhance hydrogen peroxide bleaching. Adding 12-13 ppm of Cu (III) or Fe (III) can lead to decreases of one-half or more of hydrogen peroxide and still provide about the same reduction in D.P. as with hydrogen peroxide alone. Accordingly, less bleaching agent is used. Mn (II) is not as effective as Cu (II) or Fe (III), and a mixture of Mn (II) and Fe (III) are also not as effective. CO(II) is not very effective. Kamloops D₁ pulp is more resistant to bleaching than is Kamloops D₁ pulp washed with DI water.

### EXAMPLE C

### Reduction of Degree of Polymerization at High pH with a Catalyst

Never dried pulp (centrifuged Kamloops D₁ pulp) having a consistency of 10% was mixed with 1.0% NaOH (based on pulp weight) and 2.0% H₂O₂ (based on pulp weight) in a container and bleached at 88° C. for one hour in a lab. The pH was greater than 8. A catalyst was added to increase the reduction of degree of polymerization of cellulose. A control sample has a degree of polymerization of 939. The transition metals Ca and Mg that are normally present in the mill are simulated by adding water containing low concentrations of these elemental transition metals. The results are summarized in Table 3.

TABLE 3
MILL WATER IMPACT ON BLEACHING

| | | | D.P./copper | | |
|---|---|---|---|---|---|
| | | Catalyst | number | | Cu/Fe |
| | | in water | (post- | | in final |
| Pulp | Catalyst | (ppm) | treatment) | Comment | product |
| Kamloops D1 | None | | 939 | | |
| Kamloops D1 | Water/H₂O₂/NaOH | 0 | 789 | 1.0% H₂O₂ on | 10 |
| | | | | pulp | |
| Kamloops D1 | Water/H₂O₂/NaOH | 0 | 711/0.8 | | 6/4 |
| Kamloops D1 | Water/H₂O₂/NaOH | Water* | 939 | 13 ppm Ca/ | |
| | | | | 3 ppm Mg/ | |
| | | | | 0.3 ppm Mn in | |
| | | | | water | |
| Kamloops D1 | CuSO₃ | 6 | 587 | | 32 |
| Kamloops D1 | CuSO₃ | 6/water* | 939 | 13 ppm Ca/ | |
| | | | | 3 ppm Mg/ | |
| | | | | 0.3 ppm Mn in | |
| | | | | water | |
| Kamloops D1 | CuSO₃/EDTA | 6/1 kg/ton | 616 | | 17 |
| Kamloops D1 | FeCl₃.6H₂O | 6 | 681 | | |
| Kamloops D1 | FeCl₃.6H₂O | 6/water* | 939 | 13 ppm Ca/ | |
| | | | | 3 ppm Mg/ | |
| | | | | 0.3 ppm Mn in | |
| | | | | water | |
| Kamloops D1 | FeCl₃.6H₂O/EDTA | 6/1 kg/ton | 704 | | 8/6 |

*simulated mill water made in lab with elemental metals

These results indicate that Cu (II) is a better catalyst than Fe (III). A chelating agent, such as EDTA, can be added with the catalyst to lower the degree of polymerization and simultaneously chelate transition metals. Ca and Mg in water can deactivate the catalysts and prevent cellulose degradation.

### EXAMPLE D

### Reduction of Degree of Polymerization at High pH with a Catalyst

Never dried pulp (Kamloops D₁ pulp) having a consistency of 10% was mixed with 1.5% NaOH (based on pulp weight) and 2.3% H₂O₂ (based on pulp weight) in a container and bleached at 88° C. for one hour. The pH was high at greater than 8. A catalyst was added to increase the reduction of degree of polymerization of cellulose. A control sample has a degree of polymerization of 718 and a copper number of 0.8. The results are summarized in Table 4.

TABLE 4
OTHER CATALYSTS FOR BLEACHING

| | | Catalyst | D.P./copper | |
|---|---|---|---|---|
| | | in water | number (post | |
| Pulp | Catalyst | (ppm) | treatment) | Comment |
| Kamloops D1 | None | | 939 | |
| Kamloops D1 | Water/H₂O₂/NaOH | 0 | 718/0.8 | Control |
| Kamloops D1 | Fe(II) D-gluconate | 10 | 628 | |
| | dehydrate | | | |

These results indicate that mill pulp can be degraded to very low D.P. with a Fe(II) catalyst.

### EXAMPLE E

### Reduction of Degree of Polymerization at Low pH with a Catalyst Followed by Copper Number Control

Never dried pulp (Kamloops D₁ pulp) having a consistency of 10% was mixed with 1.5% NaOH (based on pulp weight) and 2.3% H₂O₂ (based on pulp weight) in a container and bleached at 88° C. for one hour. The pH was low at between 2 and 8. A catalyst was added to increase the reduction of degree of polymerization of cellulose. A control sample has a degree of polymerization of 718 and a copper number of 0.8. The results are summarized in Table 5.

TABLE 5
OTHER CATALYSTS FOR BLEACHING

| | | | D.P./copper | |
|---|---|---|---|---|
| | | Catalyst | number | |
| | | in water | (post | |
| Pulp | Catalyst | (ppm) | treatment) | Comment |
| Kamloops | None | | 939 | |
| D1 | | | | |
| Kamloops | Water/H₂O₂/NaOH | 0 | 718/0.8 | Control |
| D1 | | | | |
| Kamloops | CuSO₃ | 1.1 | 555/1.1 | 30 minutes |
| D1 | | | | bleaching, |
| | | | | then add |
| | | | | another 1.5% |
| | | | | NaOH to |
| | | | | control copper |
| | | | | number |

These results indicate that mill pulp can be degraded to very low D.P. with a Cu(II) catalyst. The copper number can be reduced by adding sodium hydroxide after 30 minutes of bleaching.

### EXAMPLE F

### Reduction of Degree of Polymerization at Low pH with a Catalyst Followed by Copper Number Control

Never dried pulp (Kamloops D₀ pulp with pH of 3.54) having a consistency of 10% was mixed with chemicals in a container and bleached at 68° C. for 15 minutes in a lab. The pH is low at about 2 to 8. The samples were then bleached in an E_{P} stage for copper number control. The results are summarized in Table 6.

TABLE 6
USING THE CATALYST IN OTHER STAGE

| | | pH | | | | | | |
|---|---|---|---|---|---|---|---|---|
| | | (NaOH | | Cu(II) | | | | |
| | | added | | in | | | | |
| Sam- | Treat- | to | H₂O₂ | water, | EDTA* | | CU* | Fe* |
| ple | ment | adjust) | (%) | ppm | (lb/ton) | D.P.* | ppm | ppm |
| K | Control | 5 | 0 | 0 | 0 | 755 | | |
| L | Treated | 5.2 | 0.5 | 0 | 0 | 732 | | |
| M | Treated | 4.8 | 0.5 | 3 | 0 | 636 | | |
| G | Treated | 5.9 | 0.5 | 1.5 | 0 | 790 | 35 | 38 |
| H | Treated | 5.9 | 0.5 | 1.5 | 1.9 | 806 | 20 | 29 |
| I | Treated | 5.9 | 0.5 | 1.5 | 1.9 | 798 | 21 | 30 |
| J | Treated | 5.9 | 0.5 | 1.5 | 0 | 811 | 32 | 27 |
| Con- | None | 5.9 | 0 | 0 | 0 | 1318 | 27 | 33 |
| trol | | | | | | | | |

*The samples K, L, M were then bleached with 5% NaOH and 4% H₂O₂ at 88 C. for 1 hour and dried for D.P. measurement. Samples G, H, I, and J are the same treated samples which were bleached with 2.5% NaOH, 2.0% H₂O₂, and optionally EDTA, at 88 C. for 1 hour, filtered once under vacuum, and dried for D.P. and metals measurement.

The results indicate that reduction of the degree of polymerization with a catalyst can be used in a stage before an E_{P} stage to lower the amounts of chemicals required for the same D.P. reduction without a catalyst. EDTA can be added to lower the metals in pulp without affecting D.P. reduction when followed by one or more D or E stages.

### EXAMPLE G

### Reduction of Degree of Polymerization at High pH with a Catalyst

Never dried pulp (Flint River mill fluff pulp from D₁ stage) was optionally adjusted to a pH of 2.0 using H₂SO₄ and EDTA at 1 kg/ton pulp and mixed for 15 minutes at 50° C. After filtering, pulp having a consistency of 10% is mixed with tap water and 2.4% NaOH (based on pulp weight) and 3.4% H₂O₂ (based on pulp weight) in a container and bleached in bath at 88° C. for 1.0 hour in a lab. A catalyst was added to increase the reduction of degree of polymerization of cellulose. The pH was greater than 8. A control sample has a degree of polymerization of 1052 and a copper number of 0.6. The results are summarized in Table 7.

TABLE 7
USING THE CATALYSTS FOR BLEACHING FLUFF MILL PULP

| | EDTA/ | | | | | |
|---|---|---|---|---|---|---|
| | H₂SO₄ | | Catalyst | EDTA* | | Copper |
| Treatment | treatment | Catalyst | in water, ppm | (kg/ton) | D.P. | number |
| Control | Yes | No bleaching | | 1 | 1052 | 0.6 |
| Treated | Yes | Bleached | 0 | 1 | 862 | 0.9 |
| Treated | Yes | Fe(III)Cl₃ hydrate | 15 | 1 | 842 | 0.9 |
| Treated | Yes | Cu(II)SO₄ hydrate | 15 | 1 | 755 | 1.1 |
| Treated* | No | Cu(II)SO₄ hydrate | 6 | 0 | 769 | 1.6 |
| Treated** | No | Cu(II)SO₄ hydrate | 6 | 0 | 1006 | 0.7 |
| Treated* | No | Cu(II)SO₄ hydrate | 3 | 0 | 737 | 1.6 |
| Treated* | No | Co(II)(OH)2 hydrate | 3 | 0 | 909 | |
| Treated* | No | Fe(III)C1₃ hydrate | 3 | 0 | 940 | |

*0.75% NaOH and 2.3% H₂O₂ were used for bleaching.
**1.5% NaOH and 2.3% of H₂O₂ were used for bleaching.

These results indicate that a fluff grade pulp can be degraded with a catalyst, such as Cu(II) to a D.P. range that is suitable for lyocell applications. An EDTA pretreatment can lower the metals. If pH is high during D.P. reduction (greater than 8) then post addition of sodium hydroxide is not required to control copper number. Reduction of D.P. takes place without substantially increasing the copper number.

### EXAMPLE H

### Reduction of Degree of Polymerization at Low pH with a Catalyst Followed by Copper Number Control

Never dried pulp (Flint River mill fluff pulp from D₁ stage) was optionally adjusted to a pH of 2.0 using H₂SO₄ and EDTA at 1 kg/ton pulp and mixed for 15 minutes at 50° C. After filtering, pulp having a consistency of 10% is mixed with tap water and 2.4% NaOH (based on pulp weight) and 3.4% H₂O₂ (based on pulp weight) in a container and bleached in bath at 88° C. for 1.0 hour in a lab. A catalyst was added to increase the reduction of degree of polymerization of cellulose. The pH was between 2 and 8. A control sample has a degree of polymerization of 1052 and a copper number of 0.6. The results are summarized in Table 8.

TABLE 8
USING THE CATALYSTS FOR BLEACHING FLUFF MILL PULP

| | EDTA/ | | | | | |
|---|---|---|---|---|---|---|
| | H₂SO₄ | | Catalyst in | EDTA* | | Copper |
| Treatment | treatment | Catalyst | water, ppm | (kg/ton) | D.P. | number |
| Control | Yes | No bleaching | | 1 | 1052 | 0.6 |
| Treated | Yes | bleached | 0 | 1 | 862 | 0.9 |
| Treated*** | No | Cu(II)SO₄ hydrate | 6 | 0 | 810 | 1.1 |
| Treated*** | No | Cu(II)SO₄ hydrate | 11 | 0 | 774 | 1.3 |
| Treated**** | No | Cu(II)SO₄ hydrate | 3 | 0 | 773 | 1.2 |
| Treated***** | No | Cu(II)SO₄ hydrate | 3 | 0 | 763 | 1.1 |
| Treated****** | No | Cu(II)SO₄ hydrate | 2.7 | 0 | 746 | 1.0 |
| | | | | | | R₁₀/R₁₈ |
| Treated******* | No | Cu(II)SO₄ hydrate | 3 | 0 | 732 | 83.9/87.5 |

***0.45% NaOH and 2.2% H₂O₂ were used for bleaching for 0.5 hour, then 1.1% of NaOH was added to continue bleaching for another 0.5 hour.
****0.45% NaOH and 2.2% H₂O₂ were used for bleaching for 0.75 hour, then 1.1% of NaOH was added to continue bleaching for another 0.25 hour.
*****1.0% NaOH and 2.2% H₂O₂ were used for bleaching for 0.5 hour, and then 1.5% of NaOH was added to continue bleaching for another 0.5 hour.
******1.0% NaOH and 2.2% H₂O₂ were used for bleaching for 0.58 hour, and then 1.4% of NaOH was added to continue bleaching for another 0.42 hour.
*******0.8% NaOH and 2.2% H₂O₂ were used for bleaching for 0.5 hour, then 0.8% of NaOH was added to continue bleaching for another 0.5 hour.
Method for measuring R₁₀, R₁₈ is Weyerhaeuser method: AM T-235

These results indicate that D.P. reduction at low pH (less than 8) followed by alkali addition and high pH (greater than 8) will control copper number.

The results indicate that a fluff grade pulp can be degraded with a Cu(II) catalyst to a D.P. range that is suitable for lyocell (low D.P. and low copper number). A chelating agent, such as EDTA can be used to lower metals.

### EXAMPLE I

### Reduction of Degree of Polymerization at High pH with a Catalyst

Never dried pulp (Flint River D₁ pulp) was used for making low D.P. pulp in a lab. The amounts of NaOH and H₂O₂ used are provided in Table 9. A catalyst was added to increase the reduction of degree of polymerization of cellulose. The pH was greater than 8. A control sample has a degree of polymerization of 1272 and a copper number of 0.6.

TABLE 9
USING THE CATALYST FOR BLEACHING FLUFF MILL PULP

| | | | Catalyst | | D.P. | |
|---|---|---|---|---|---|---|
| | NaOH/H₂O₂ | | in water, | Final pH | (post | Copper |
| Treatment | (lb/lb) | Catalyst | ppm | (Eop) | treatment) | number |
| Control | | | | | 1272 | 0.6 |
| Treated | 11/51 | Cu(II)SO₄ hydrate | 3.3 | 6.3 | 886 | 1.4 |
| Treated | 10/50 | Cu(II)SO₄ hydrate | 2.3 | 4.2 | 730 | 2.2 |

High pH, degree of polymerization reduction did not work well due to high copper number. Too much D.P. reduction in one stage will generate pulp with high copper number.

### EXAMPLE J

### Reduction of Degree of Polymerization at Low pH with a Catalyst Followed by Copper Number Control

Never dried pulp (Flint River D₁ pulp) was used for making low DP pulp in a lab. The amounts of NaOH and H₂O₂ used are provided in Table 10. A catalyst was added to increase the reduction of degree of polymerization of cellulose. The pH was low at between 2 and 8. A control sample has a degree of polymerization of 1272 and a copper number of 0.6

TABLE 10
USING THE CATALYST FOR BLEACHING FLUFF MILL PULP

| | | | Catalyst | | D.P. | |
|---|---|---|---|---|---|---|
| | NaOH/H₂O₂ | | in water, | Final pH | (post | Copper |
| Treatment | (lb/lb) | Catalyst | ppm | (Eop) | treatment) | number |
| Control | | | | | 1272 | 0.6 |
| Treated* | 0/50 | Cu(II)SO₄ hydrate | 3.5 | 12 | 783 | 1.1 |

*0% NaOH and 1% H₂O₂ were used for bleaching for 0.5 hours, then 1% NaOH was added to continue for another 0.5 hour.

These results indicate that a normal fluff D₁ pulp can be degraded with a catalyst to a D.P. range that is suitable for lyocell applications (low D.P. and low copper number). Alkaline addition is needed to control copper number to less than 2.

### EXAMPLE K

### Reduction of Degree of Polymerization at Low pH with a Catalyst Followed by Copper Number Control

Never dried pulp (Flint River post oxygen wash (POW) pulp) was used for making low D.P. pulp in a lab. The amounts of NaOH and H₂O₂ used are provided in Table 11. A catalyst was added to increase the reduction of degree of polymerization of cellulose. The pH was about 2 to 8. A control sample has a degree of polymerization of 1272 and a copper number of 0.6.

TABLE 11
USING THE CATALYST FOR BLEACHING FLUFF MILL PULP

| | | | Catalyst | | | |
|---|---|---|---|---|---|---|
| | NaOH/H₂O₂ | | in water, | Final pH | | |
| Treatment | (lb/lb) | Catalyst | ppm | (Eop) | | |
| | | | | | D.P. | |
| | | | | | (post | Copper |
| | | | | | treatment) | number |
| Control | | | | | 1272 | 0.6 |
| | | | | | | Viscosity |
| | | | | | | (FB) |
| POW** | 0/0 | Cu(II)SO₄ hydrate | 6.6 | 8 | 1156 | 66 |
| POW** | 0/10 | Cu(II)SO₄ hydrate | 11 | 8.6 | 1128 | 62 |
| POW** | 0/10 | Cu(II)SO₄ hydrate | 11 | 2.5 | 1076 | 55 |
| POW*** | 0/10 | Cu(II)SO₄ hydrate | 11 | 6 | 1015 | 47 |
| | | | | | Mg/TM | |
| POW**** | 0/10 | Cu(II)SO₄ hydrate | 6 | 8.11 | 3.5 | 74 |
| POW**** | 0/10 | Cu(II)SO₄ hydrate | 6 | 4.45 | 3.5 | 68 |
| POW**** | 0/10 | Cu(II)SO₄ hydrate | 6 | 3.10 | 3.5 | 60 |

**70° C., 70 minutes.
***88° C. and 70 minutes.
****70° C. and 120 minutes. TM is the total of transition metal (Fe, Mn, Cu, Co, Ni) in pulp and bleaching liquid.
Method for measuring falling ball (FB) viscosity: Weyerhaeuser method: AM W-PPD-8
Method for measuring metals: Weyerhaeuser method AM T-266M/E-6010

A POW pulp can be bleached with hydrogen peroxide and a catalyst, such as Cu (II), to lower viscosity at a pH in the range of 2 to 8 and a temperature range of 50 to 100° C. If POW pulp viscosity is lowered with a catalyst, then a normal bleaching sequence used for fluff pulp can be used for lyocell production. Productivity can be increased, chemical cost is lowered, and energy will be saved. Catalysts can be used in bleaching stage including D or E stages.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A process for making a composition for conversion to lyocell fiber, the process comprising:
contacting a pulp comprising cellulose and at least 7% hemicellulose with an oxidant and a catalyst for a first period of time to reduce the average degree of polymerization of the cellulose at a pH of 2 to 8, followed by contacting the pulp with an alkali for a second period of time to reduce the copper number of the pulp to less than 2, without substantially reducing the hemicellulose content of the pulp, wherein the catalyst amount is less than 30 ppm.

2. The process of claim 1, wherein the catalyst comprises a metal ion from at least one of Fe(II), Fe(III), Mn(II), Cu(II), Cu(I), Co(II), Co(III), Ni(II), the salts thereof, or any combination thereof.

3. The process of claim 1, wherein the amount of oxidant is about 1% to about 4% based on the weight of the pulp.

4. The process of claim 1, wherein the temperature during the reduction of degree of polymerization. is about 50° C. to about 100° C.

5. The process of claim 1, further comprising adding a chelating agent.

6. The process of claim 5, wherein the chelating agent is at least one of aminopolycarboxylic acid (APCA), ethylenediaminetetraacetic acid (EDTA), diethylene triamine pentaacetic acid (DTPA), nitrilotriacetic acid (NTA), phosphonic acid, ethylenediaminetetramethylene-phosphonic acid (EDTMP), diethylenetriaminepentamethylenephosphonic acid (DTPMP), nitrilotrimethylenephosphonic acid (NTMP), a polycarboxylic acid, a gluconate, a citrate, a polyacrylate, a polyaspartate or any combination thereof.

7. The process of claim 5, wherein the amount of chelating agent is about 0.1% based on the weight of the pulp.

8. The process of claim 1, wherein the reduction in degree of polymerization is about 10% to about 15%.

9. The process of claim 1, further comprising adding an acid to maintain the pH at about 2 to about 8.

10. The process of claim 1, further comprising adding carbon dioxide to maintain the pH at about 2 to about 8.

11. The process of claim 1, wherein the first period of time is at least 15 minutes.

12. The process of claim 1, wherein the first period of time is at least 45 minutes.

13. The process of claim 1, wherein the oxidant is hydrogen peroxide.

14. A pulp bleaching sequence, comprising:
a D stage; and
an E stage, wherein a pulp is bleached in the presence of a catalyst after the D stage and before the E stage at a pH of 2 to 8, and the copper number is reduced in the E stage.

15. A pulp bleaching sequence, comprising:
a D stage; and
an E stage, wherein the pulp is bleached in the presence of a catalyst before the D and E stages at a pH of 2 to 8, and the copper number is reduced in the E stage.

16. A pulp bleaching sequence, comprising:
a first E stage; and
a second E stage, wherein the pulp is bleached in the first E stage in the presence of a catalyst at a pH of 2 to 8, and the copper number is reduced in the second E stage.
